(19) United States
(12) Patent Application Publication
(10) Pub. No.: US 2017/0004517 A1
(43) Pub. Date: Jan. 5, 2017

(54) SURVEY SYSTEM AND METHOD

(71) Applicant: Speetra, Inc., Dallas, TX (US)

(72) Inventors: Pawan Jaggi, Plano, TX (US); Abhijeet Sangwan, Allen, TX (US)

(73) Assignee: Speetra, Inc., Dallas, TX (US)

(21) Appl. No.: 15/265,432

(22) Filed: Sep. 14, 2016

Related U.S. Application Data
(63) Continuation-in-part of application No. 14/335,214, filed on Jul. 18, 2014.

(51) Int. Cl. G06Q 30/02; G10L 25/63; G10L 15/18; G06Q 50/00

(52) U.S. Cl. CPC G06Q 30/0203; G06Q 50/01; G10L 25/63; G10L 15/1815

(57) ABSTRACT

A system and method for providing reviews that includes a network, a first client device connected to the network, a second client device connected to the network, a survey server connected to the network, and a social media server connected to the network. The method includes the steps of sending a message with a portion of bio information sent by the second client device; receiving a message with a code; sending a message with a link to a social media selection page; and, sending the social media selection page, which comprises one or more portions of the social media information.

### CROSS-REFERENCE TO RELATED APPLICATIONS

This application is a continuation in part of U.S. application Ser. No. 14/335,214 filed Jul. 18, 2014, which is incorporated herein by reference in its entirety to provide continuity of disclosure.

### FIELD OF THE INVENTION

The present invention relates to systems and methods for speech recognition. In particular, the present invention relates to a system and method for capturing and analyzing speech to determine emotion and sentiment.

### BACKGROUND OF THE INVENTION

Statistical surveys are undertaken for making statistical inferences about the population being studied. Surveys provide important information for many kinds of public information and research fields, e.g., marketing research, psychology, health professionals, and sociology. A single survey typically includes a sample population, a method of data collection and individual questions the answers to which become data that are statistically analyzed. A single survey focuses on different types of topics such as preferences, opinions, behavior, or factual information, depending on its purpose. Since survey research is usually based on a sample of the population, the success of the research is dependent on the representativeness of the sample with respect to a target population of interest to the researcher. That target population ranges from the general population of a given country to specific groups of people within that country, to a membership list of a professional organization, or a list of customers who purchased products from a manufacturer.

Further, the reliability of these surveys strongly depends on the survey questions used. Usually, a survey consists of a number of questions that the respondent has to answer in a set format. A distinction is made between open-ended and closed-ended questions. An open-ended question asks the respondent to formulate his or her own answer, whereas a closed-ended question has the respondent pick an answer from a given number of options. The response options for a closed-ended question should be exhaustive and mutually exclusive. Four types of response scales for closed-ended questions are distinguished: dichotomous, where the respondent has two options; nominal-polytomous, where the respondent has more than two unordered options; ordinal-polytomous, where the respondent has more than two ordered options; and bounded continuous, where the respondent is presented with a continuous scale. A respondent's answer to an open-ended question can be coded into a response scale afterwards, or analyzed using more qualitative methods.

There are several ways of administering a survey. Within a survey, different methods can be used for different parts. For example, interviewer administration can be used for general topics but self-administration for sensitive topics. The choice between administration modes is influenced by several factors, including costs, coverage of the target population, flexibility of asking questions, respondents' willingness to participate, and response accuracy. Different methods create mode effects that change how respondents answer.

Recently, most market research companies in the United States have developed online panels to recruit participants and gather information. Utilizing the Internet, thousands of respondents can be contacted instantly rather than the weeks and months it used to take to conduct interviews through telecommunication and/or mail. By conducting research online, a research company can reach out to demographics they may not have had access to when using other methods. Big-brand companies from around the world pay millions of dollars to research companies for public opinions and product reviews by using these free online surveys. The completed surveys attempt to directly influence the development of products and services from top companies.

Online surveys are becoming an essential research tool for a variety of research fields, including marketing, social, and official statistics research. According to the European Society for Opinion and Market Research (“ESOMAR”), online survey research accounted for 20% of global data-collection expenditure in 2006. They offer capabilities beyond those available for any other type of self-administered questionnaire. Online consumer panels are also used extensively for carrying out surveys. However, the quality of the surveys conducted by these panels is considered inferior because the panelists are regular contributors and tend to be fatigued.

Further, online survey response rates are generally low and also vary extremely—from less than 1% in enterprise surveys with e-mail invitations to almost 100% in specific membership surveys. In addition to refusing participation, terminating surveying during the process or not answering certain questions, several other non-response patterns can be observed in online surveys, such as lurking respondents and a combination of partial and question non-responsiveness.

Therefore, there is a need in the art for a system and method for capturing and analyzing speech to determine emotion and sentiment from a survey.

### SUMMARY

A system and method for determining a sentiment from a survey is disclosed. The system includes a network, a survey system connected to the network, an administrator connected to the network, and a set of users connected to the network. The method includes the steps of receiving a set of questions for the survey, a set of predetermined answers to the set of questions, a set of parameters, and a target list, generating a survey message from the target list and the set of parameters, sending the survey message to the set of users, sending the set of questions and the set of predetermined answers in response to the survey message, receiving a set of audio responses to the set of questions, receiving a set of text responses to the set of questions, receiving a set of selected answers to the set of questions, determining a set of sentiments from the set of audio responses, the set of text responses, and the set of selected answers, and compiling the set of sentiments. A report is generated from the compiled set of sentiments and sent to the administrator for analysis.

### BRIEF DESCRIPTION OF THE DRAWINGS

In the detailed description of the preferred embodiments presented below, reference is made to the accompanying drawings.

FIG. 1 is a schematic of the system of a preferred embodiment.

FIG. 2 is flowchart of a method for delivering and analyzing a survey of a preferred embodiment.

FIG. 3A is flowchart of a method for analyzing a set of audio responses to a survey of a preferred embodiment.

FIG. 3B is flowchart of a method for determining speech sentiment of a preferred embodiment.

FIG. 4A is flowchart of a method for analyzing a set of text responses to a survey of a preferred embodiment.

FIG. 4B is a flowchart of a method for determining a written sentiment of a preferred embodiment.

FIG. 5 is flowchart of a method for compiling survey results of a preferred embodiment.

FIG. 6 is a flowchart of a system and method for posting a review.

FIG. 7 is a diagram of a system and method for communicating using text messages and email.

### DETAILED DESCRIPTION

It will be appreciated by those skilled in the art that aspects of the present disclosure may be illustrated and described in any of a number of patentable classes or contexts including any new and useful process or machine or any new and useful improvement. Aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Further, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. For example, a computer readable storage medium may be, but not limited to, an electronic, magnetic, optical, electromagnetic, or semiconductor system, apparatus, or device, or any suitable combination of the foregoing. More specific examples of the computer readable storage medium would include, but are not limited to: a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. Thus, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. The propagated data signal may take any of a variety of forms, including, but not limited to, electro-magnetic, optical, or any suitable combination of them. A computer readable signal medium may be any computer readable medium that is not a computer readable storage medium and that can communicate, propagate, or transport a program for use by or in connection with an instruction execution system, apparatus, or device.

Computer program code for carrying out operations for aspects of the present disclosure may be written in any combination of one or more programming languages, including an object oriented programming language such as Java, C++, C#, .NET, Objective C, Ruby, Python SQL, or other modern and commercially available programming languages.

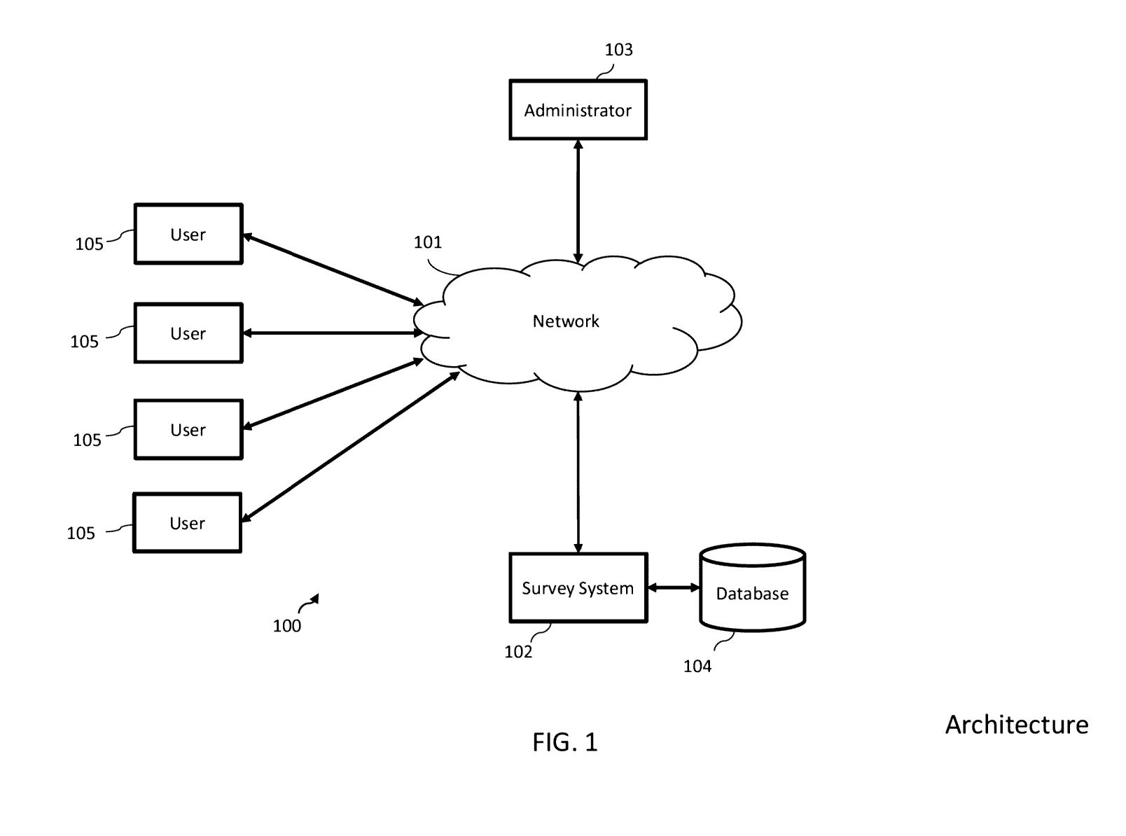

Referring to FIG. 1, system 100 includes network 101, survey system 102 connected to network 101, administrator 103 connected to network 101, and set of users 105 connected to 101.

In a preferred embodiment, network 101 is the Internet. Survey system 102 is further connected to database 104 to communicate with and store relevant data to database 104. Users 105 are connected to network 101 by communication devices such as smartphones, PCs, laptops, or tablet computers. Administrator 103 is also connected to network 101 by communication devices.

In one embodiment, user 105 communicates through a native application on the communication device. In another embodiment, user 105 communicates through a web browser on the communication device.

In a preferred embodiment, survey system 102 is a server.

In a preferred embodiment, administrator 103 is a merchant selling a good or service. In this embodiment, user 105 is a consumer who purchased the good or service from administrator 103. In another embodiment, administrator 103 is an advertising agency conducting consumer surveys on behalf of a merchant.

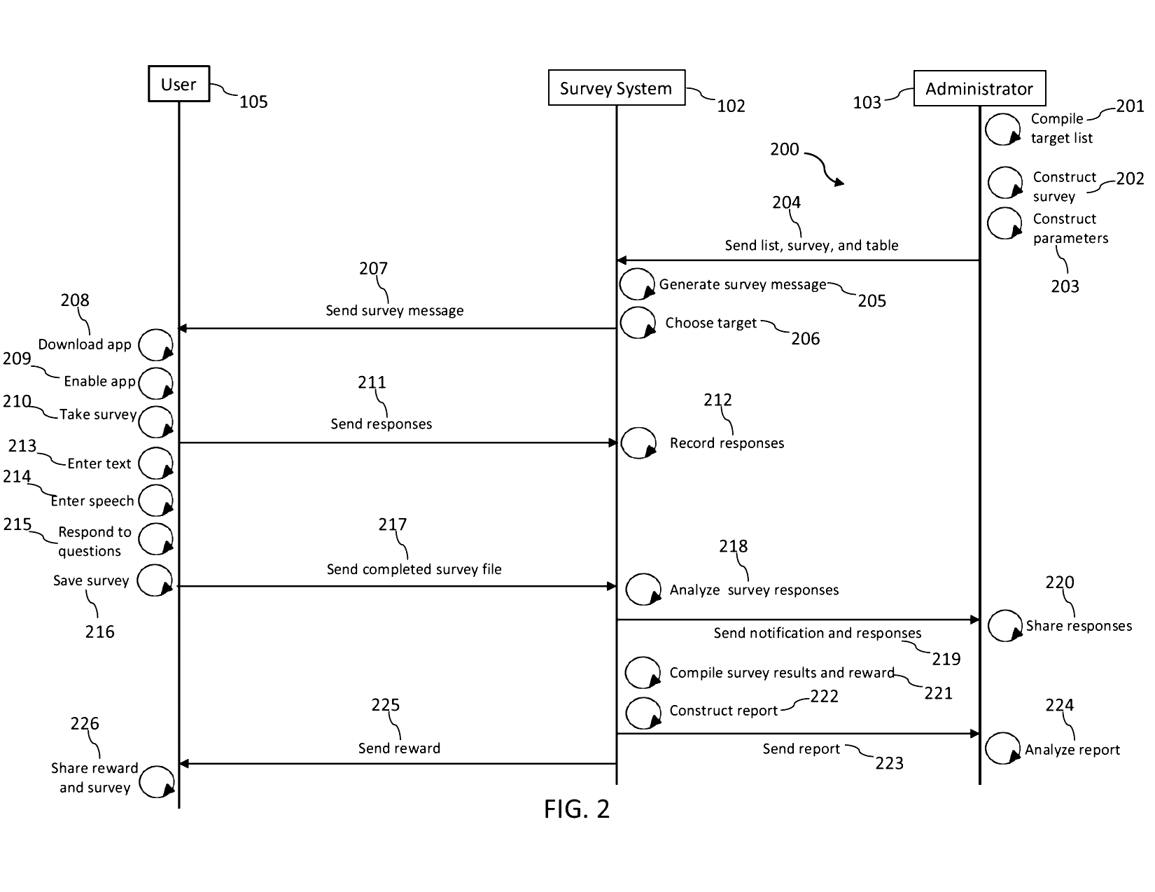

Referring to FIG. 2, method 200 for generating and distributing surveys is described. In step 201, administrator 103 compiles a list of users 105 to target to receive a survey. In one embodiment, the list includes customers who have submitted their contact information by purchasing a product. In this embodiment, the list is generated from a point of sales (PoS) system. In another embodiment, the list is produced from contact information obtained from e-mail accounts such as Gmail, from social media, or any web application. In this embodiment, the list is retrieved through application program interfaces (APIs) of any web application or enterprise database.

In step 202, administrator 103 constructs a survey by drafting a list of questions and a set of predetermined answers to the list of questions. In one embodiment, the list of questions is displayed as text.

In another embodiment, the list of questions is recorded and presented in audio. In one embodiment, the recorded audio questions are presented to the user in a telephone call, as will be further described below.

In another embodiment, a digital avatar is used to present the list of questions via animation. In this embodiment, administrator 103 records the survey in audio format and the digital avatar “speaks” the recorded audio when presented to a user.

In a preferred embodiment, each predetermined answer of the set of predetermined answers corresponds to a sentiment. For example, each survey question includes five predetermined answers, each listing a sentiment: very unsatisfied, unsatisfied, somewhat satisfied, satisfied, and very satisfied. In one embodiment, the set of predetermined answers are selected using a set of radio buttons. In this embodiment, each radio button lists a sentiment. In another embodiment, the set of predetermined answers are selected using a set of graphical emoticons. In this embodiment, each emoticon corresponds to a sentiment. Any means of selection may be employed.

In step 203, administrator 103 constructs a set of parameters for the survey. In this step, the set of parameters includes a set of desired demographics of the targeted users that will receive the survey and a set of filter criteria by which the survey is to be filtered. The set of parameters includes a subset of questions that may be asked depending on the time, location, language, and demographics of the user. The set of parameters further includes a set of topical keywords and phrases related to a specific industry or business vocabulary. For example, in a survey regarding social networks the words “tweet” or “selfie” are included for comparison to a user's response.

The set of parameters further includes a reward sent to a user based on a set of reward criteria that the user must meet in order to receive the reward. The set of reward criteria includes a predetermined number of questions that must be answered or a predetermined response to a question or set of questions. For example, the reward is an electronic gift card, a voucher to be redeemed at a point of sale, or a good to be shipped to the user.

In one embodiment, the set of parameters includes a set of weights for determining the reward as will be further described below.

The set of parameters further includes any recommended comments that the administrator desires to be included in a report. For example, the set of recommended comments includes survey responses having only positive, negative, or neutral sentiments.

The set of parameters includes a set of notifications that administrator 103 receives. The set of notifications will notify administrator 103 when survey system 102 receives a positive, a negative, and/or a neutral response.

In step 204, the target list, survey, and set of parameters are sent to survey system 102 and saved into database 104.

In step 205, a survey message is generated. In step 206, survey system 102 selects a target user according to the target list and the set of parameters. In step 207, a survey message is sent to each user 105. In a preferred embodiment, the survey message is a link sent via a text message, an instant message, an email message, or a social media message, such as Facebook, Twitter, and Google Plus. In one embodiment, the survey message is sent via mobile push notification. Any electronic message may be employed.

In step 208, user 105 downloads a survey app after selecting the link. It will be appreciated by those skilled in the art that the survey app is not required in that a web application may be employed to take the survey. In this step, user 105 registers an account with survey system 102 by entering contact and demographic information including a name, age, language, and an email address. In step 209, user 105 enables the survey app. In one embodiment, user 105 selects a logo of the survey app. In another embodiment, user 105 scans a bar code or a QR code to enable the survey app. In another embodiment, user 105 scans an NFC tag or an RFID tag to enable the survey app.

In step 210, user 105 initiates the survey using the survey app by selecting a button to take the survey. In this step, the survey app downloads the survey and saves the location, time, and communication device information including device model number, operating system type, and web browser type and version into a survey file. In one embodiment, the location is automatically determined by GPS on the user communication device. Other means of automatically detecting the location of the user communication device may be employed.

In one embodiment, the survey app initiates a telephone call via the user communication device to take the survey. In this embodiment, the list of questions is presented to user 105 over the telephone call and a set of audio responses are recorded using an interactive voice response (IVR) system. In step 211 in this embodiment, the set of audio responses is sent to survey system 102 via telephone. In step 212 in this embodiment, the survey system 102 records the set of audio responses.

In step 213, user 105 enters text as a response to a survey question using a keyboard. In step 214, user 105 enters voice audio as a response to a survey question. In this step, user 150 selects a button to initiate and stop voice recording. The survey app turns on and off the device microphone to capture audio responses.

In step 215, user 105 responds to a survey question by selecting a predetermined answer of the set of predetermined answers. In step 216, the completed survey and the entered responses are saved in the survey file. In step 217, the survey file is sent to survey system 102. In step 218, the survey responses are analyzed, as will be further described below as methods 300 and 400. In step 219, any notifications and responses requested by administrator 103 in the set of parameters are sent to administrator 103.

In step 220, administrator 103 shares the responses by electronic messages such as email, text message, and social media such as Facebook, Twitter, and Linkedln. Any electronic message may be employed.

In step 221, the survey results and a reward are compiled, as will be further described below. In step 222, a report of the survey results is generated. The report includes a set of recommended comments based on the set of parameters. The set of recommended comments may include survey responses that included the strongest sentiment of positive, negative, or neutral sentiments. In step 223, the report is sent to administrator 103. In step 224, the report is analyzed. In this step, administrator 103 takes corrective action in response to any negative responses. In step 225, the reward is sent to user 105. In step 226, the reward may be shared on social media to entice other users to take part in the survey.

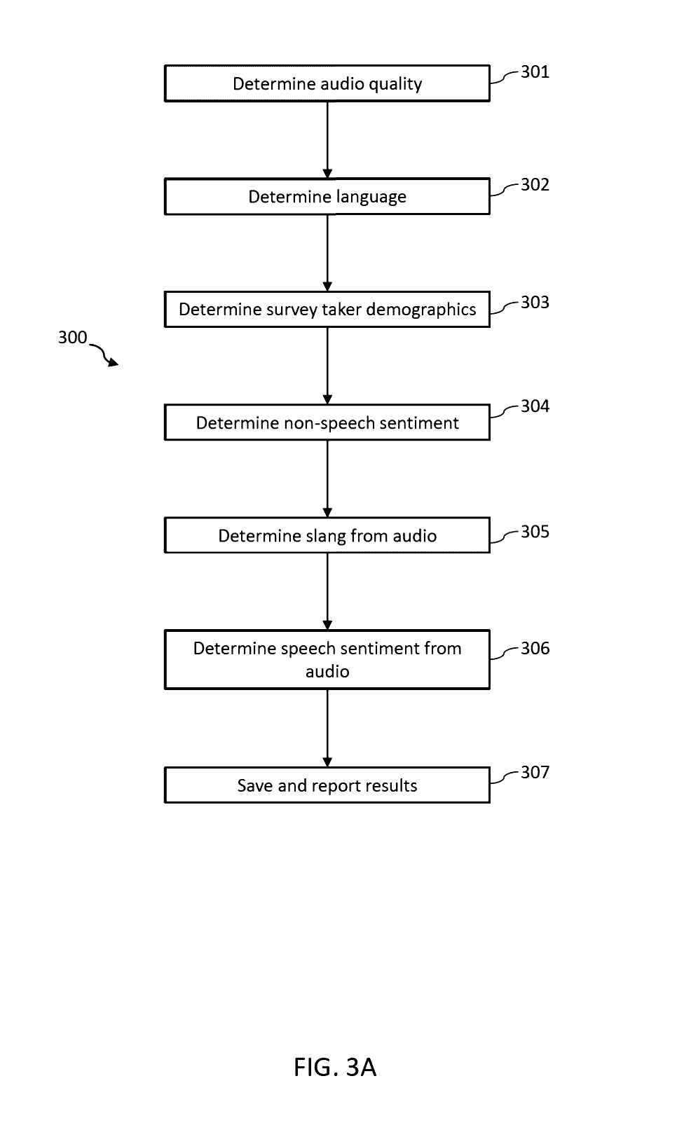

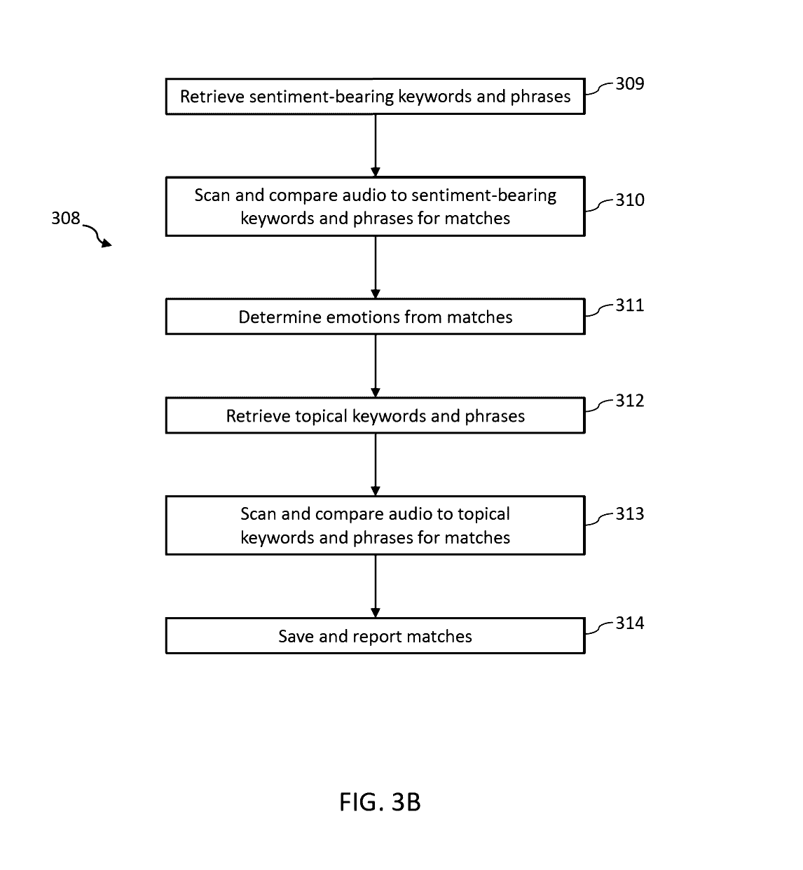

Referring to FIG. 3A, step 218 is further described as method 300 for analyzing a set of audio responses. In step 301, the audio quality of the set of audio responses is determined. In this step, a signal to noise ratio is computed. If the signal to noise ratio is greater than a predetermined ratio, then method 300 continues. In step 302, a language of the set of audio responses is determined. In one embodiment, the language is determined from the language of the survey questions.

In step 303, the demographics of the user are determined. In this step, the demographics are retrieved from the user's account registration in the database. In step 304, a non-speech sentiment is determined from each audio response. In this step, the pitch, tone, inflections, of each audio response is determined by examining the audio file for any sudden changes in frequency greater than a predetermined range of frequencies. In step 305, any slang used in the set of audio responses is determined. In this step, a set of slang words and phrases, including profanity, are retrieved from a database. Each of the set of slang words and phrases is an audio fingerprint. Each audio fingerprint is a condensed acoustic summary that is deterministically generated from an audio signal of the word or phrase. The set of audio responses is scanned and compared to the set of slang words and phrases for any matches.

In step 306, a speech sentiment is determined from the set of audio responses, as will be further described below. In step 307, the demographics, non-speech sentiment, slang, and speech sentiment, are saved for later reporting.

Referring to FIG. 3B, step 306 is further described as method 308. In step 309, a set of sentiment-bearing keywords and phrases is retrieved from a database. Each keyword or phrase includes a corresponding emotion. Each of the set of sentiment-bearing keywords and phrases is an audio fingerprint. In step 310, the set of audio responses is scanned and compared to the set of sentiment-bearing keywords and phrases for any matches. In step 311, any emotions are determined from the set of matches. The corresponding emotion of each matched keyword or phrase is summed according to each emotion. For example, a total of happy matched keywords or phrases, a total of sad matched keywords or phrases, and a total of angry matched keywords or phrases are calculated. In one embodiment, if any of the totals is a greater than a predetermined number, then that total is saved. In another embodiment, each total is ranked. The ranked totals are saved. In another embodiment, each emotion has a corresponding weight. In this embodiment, the weights of each emotion are summed and the weight totals are ranked.

In step 312, a set of topical keywords and phrases are retrieved from the database. Each of the set of topical keywords and phrases is an audio finger print. In step 313, the set of audio responses is scanned and compared to the set of topical keywords and phrases for any matches. In step 314, the set of sentiment matches and the set of topical matches are saved for later reporting.

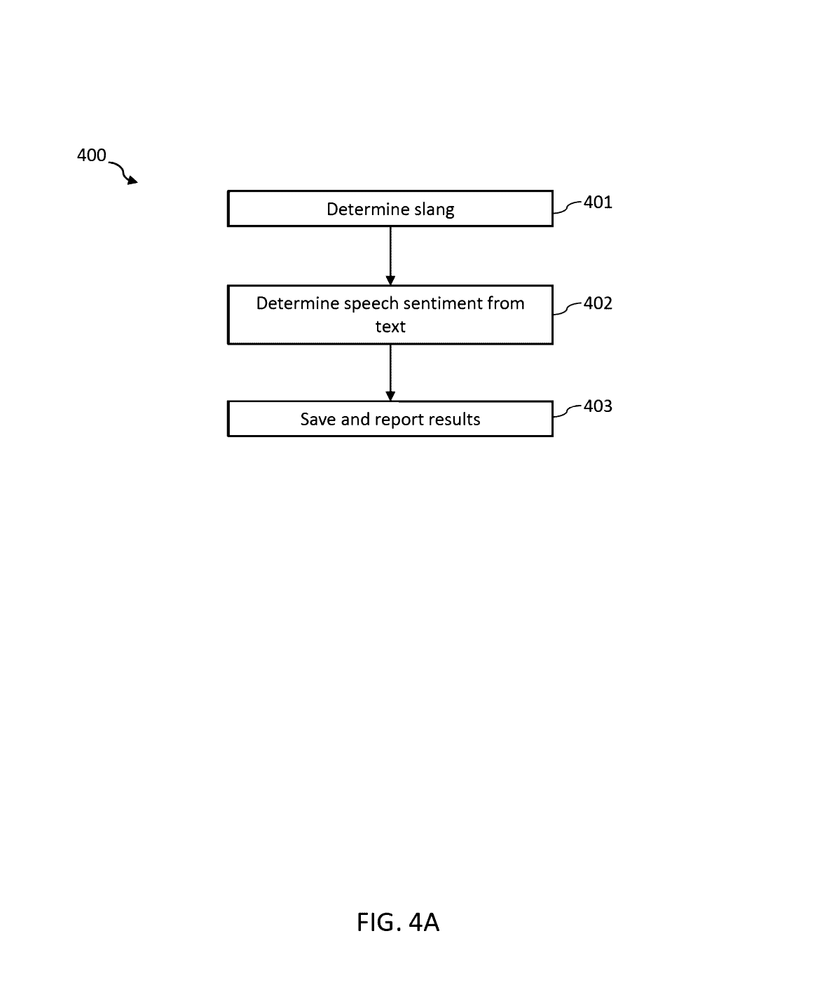

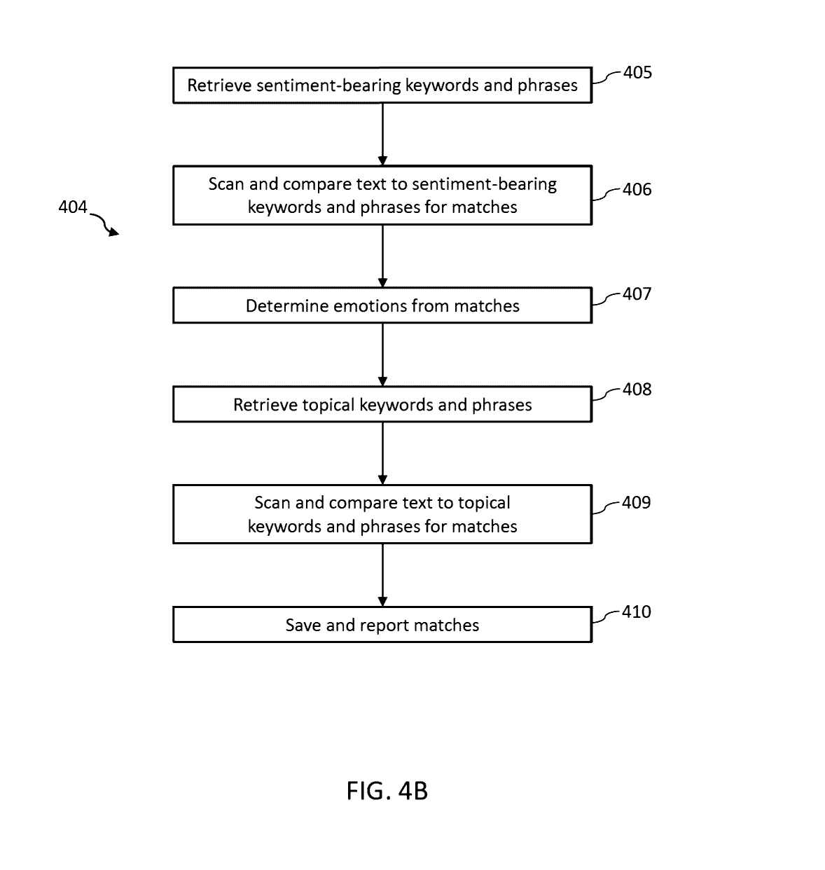

Referring to FIG. 4A, step 218 is further described as method 400 for analyzing text responses. In step 401, any slang used in the set of text responses is determined. In this step, a set of slang words and phrases, including profanity, are retrieved from a database.

The set of text responses is scanned and compared to the set of slang words and phrases for any matches. In step 402, a text sentiment is determined from the set of text responses, as will be further described below. In step 403, the demographics, non-speech sentiment, slang, and text sentiment are saved for later reporting.

Referring to FIG. 4B, step 402 is further described as method 404. In step 405, a set of sentiment-bearing keywords and phrases is retrieved from a database. Each keyword or phrase includes a corresponding emotion. In step 406, the set of text responses is scanned and compared to the set of sentiment-bearing keywords and phrases for any matches. In step 407, any emotions are determined from the set of matches. The corresponding emotion of each matched keyword or phrase is summed according to each emotion. In one embodiment, if any of the totals is a greater than a predetermined number, then that total is saved. In another embodiment, each total is ranked. The ranked totals are saved. In another embodiment, each emotion has a corresponding weight. In this embodiment, the weights of each emotion are summed and the weight totals are ranked.

In step 408, a set of topical keywords and phrases are retrieved from the database. In step 409, the text responses are scanned and compared to the set of topical keywords and phrases for any matches. In step 410, the set of sentiment matches and the set of topical matches are saved for later reporting.

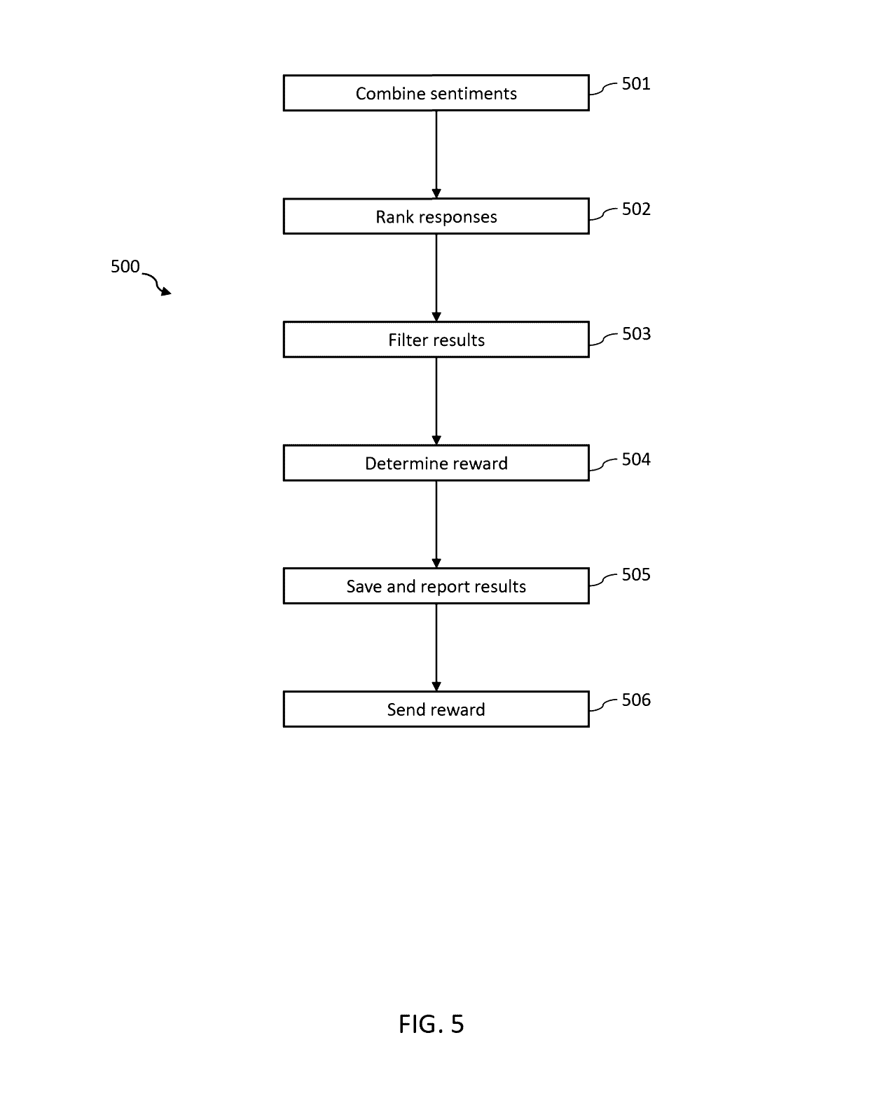

Referring to FIG. 5, step 221 is further described as method 500. In step 501, the set of audio responses, the set of text responses, and the set of selected predetermined answers are combined into a set of combined responses for the survey. The set of combined responses include any topical matches and sentiment matches.

In step 502, the set of combined responses is ranked based on criteria pre-selected by the administrator. In this step, the set of combined responses may be ranked based on sentiment. In step 503, the set of combined responses are filtered. In this step, the set of responses are filtered according to the set of parameters selected by the administrator. For example, the survey responses may be filtered according to gender, age, location, language, or user communication device type. The set of combined responses may be further filtered to filter out responses having poor audio quality, using profanity or responses with positive, neutral, or negative responses.

In step 504, a reward is determined for the user. In this step, the reward is determined from the set of combined responses. For example, if the user submitted a number of positive responses that exceed a predetermined number of positive responses, then the user receives the reward. In another example, if the user completed the survey, then the user receives the reward. If the user does not meet the criteria, then no reward is sent. In one embodiment, a weight is assigned to each of the set of matched sentiment-bearing keywords or phrases and/or the set of matched topical keywords. The set of weights are summed and if the total of summed weights is greater than a predetermined total, then a reward is sent. If the total of summed weights is less than the predetermined total, then a reward is not sent.

In step 505, the filtered combined responses including any topical matches are saved and reported to the administrator. In step 506, the reward is sent to the user, if the user has met the predetermined criteria.

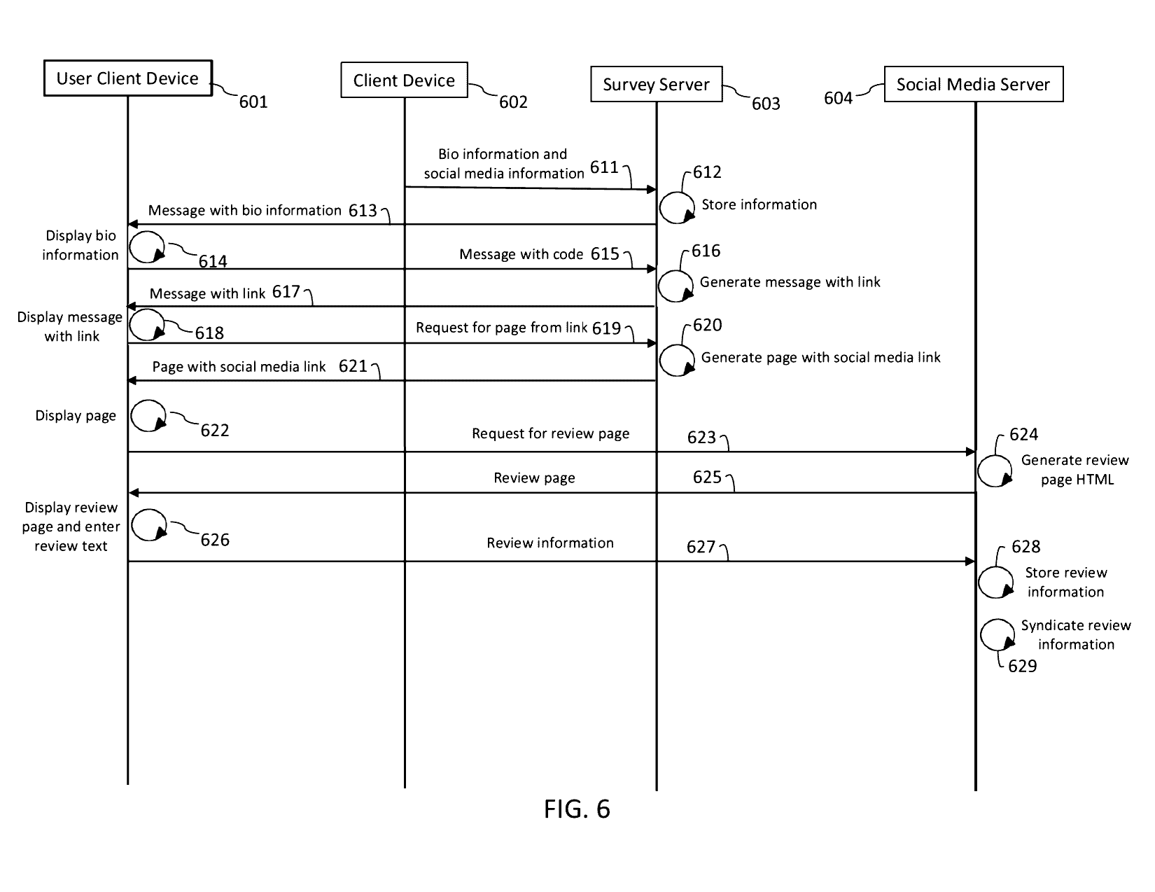

Referring to FIG. 6, a system comprising user client device 601, client device 602, survey server 602, and social media server 604 perform a method for providing a review.

User client device 601 is a communication device such as the communication device of user 105 of FIG. 1. In one embodiment, the operator of client device 601 uses client device 601 to receive biographical information about a technician that provides a service to the operator of client device 601.

Client device 602 is a communication device such as the communication device of user 105 of FIG. 1. The operator of client device 602 uses client device 602 to configure survey server 603 to allow the operator of user client device 601 to provide a review. In one embodiment, the operator of client device 602 is the employer of a technician that provides a service to the operator of user client device 601.

Survey server 603 is a server, such as a server of survey system 102 of FIG. 1. In one embodiment, survey server 603 allows each one of one or more businesses to configure biographical information for technicians and social media website information to allow customers to review the technicians on social media websites.

Social media server 604 is a server of a social media website. In one embodiment, social media server 604 is a server of one of Facebook, Google, Yelp, Twitter, and the like.

In step 611, bio information and social media information is sent from client device 602 and is subsequently received by survey server 603. In one embodiment, the bio information includes information about an employee of the operator of client device 602, such as the employee's name, identification number, phone number, email address, picture, length of employment, and so on. In one embodiment, the social media information identifies the accounts or public pages of one or more social media websites that are associated with the operator of client device 602.

In step 612, the information received from client device 602 is stored by survey server 603.

In step 613, a message with bio information is sent from survey server 612 and is subsequently received by user client device 601. In one embodiment, the message is a text message sent to the phone number of user client device 601 and includes the name, identification number, and length of employment of a technician that provides a service to the operator of client device 601.

In step 614, at least a part of the bio information is displayed by user client device 601. In one embodiment, the part of the bio information that is displayed includes one or more of the name, identification number, phone number, and email address of the technician.

In step 615, a message is sent from user client device 601 and is subsequently received by survey server 603. In one embodiment, the message is a text message that includes the word “REVIEW” as the body of the message to indicate that the operator of client device 601 would like to provide a review of the technician.

In step 616, a message with a link is generated by survey 603.

In step 617, the message with the link is sent from survey server 603 and is subsequently received by user client device 601. In one embodiment, the message is a text message that includes a hyperlink associated with a web page that is served by survey server 603. In one embodiment, the link to the web page is a link to a social media selection page hosted by survey server 603 that allows for the selection of a page from social media server 604.

In step 618, the message with the link is displayed by user client device 601.

In step 619, a request is sent from user client device 601 and is subsequently received by survey server 603. In one embodiment, the request is sent after the link from the message is selected by the operator of client device 601 from a messaging application that displayed the message with the link. In response to selecting the link, a browser application is opened to process the link and send a hypertext transfer protocol (HTTP) request to survey server 603.

In step 620, a page with one or more social media links are generated by survey server 603. In one embodiment, the page with the social media links are generated in response to receiving the request from user client device 601.

In step 621, the page with one or more social media links is sent from survey server 603 and is subsequently received by user client device 601. In one embodiment, the page includes an image associated with the operator of client device 602. Each of the social media links identifies for a particular social media website, the account or public page associated with the operator of client device 602.

In step 622, the page is displayed by user client device. In one embodiment, the image associated with the operator of client device 602 is part of a hyperlink that when selected, causes user client device 601 to request the webpage associated with the operator of client device 602.

In step 623, a request for a review page is sent from user client device 601 and is subsequently received by social media server 604. In one embodiment, the request is sent in response to selecting one of the social media links displayed on the page with social media links by user client device 601.

In step 624, the review page is generated by social media server 604. In one embodiment, the review page includes hypertext markup language (HTML) code.

In step 625, a review page is sent by social media server 604 and is subsequently received by user client device 601. In one embodiment, the review page is the social media page of the operator of client device 602.

In step 626, the review page is displayed by user client device 601 and review text is entered. In one embodiment, the display review page includes an edit box field into which the user of client device 601 inserts review information.

In step 627, the review information is sent from user client device 601 and is subsequently received by social media server 604. In one embodiment, the review information includes comments in the form of one or more of text, video, audio, images, and so on about the service received by the technician.

In step 628, the review information is stored by social media server 604.

In step 629, the review information is syndicated by social media server 604, In one embodiment, the review information is syndicated by social media server 604 by publishing the review information to other client devices that visit or request the social media page associated with the operator of client device 602.

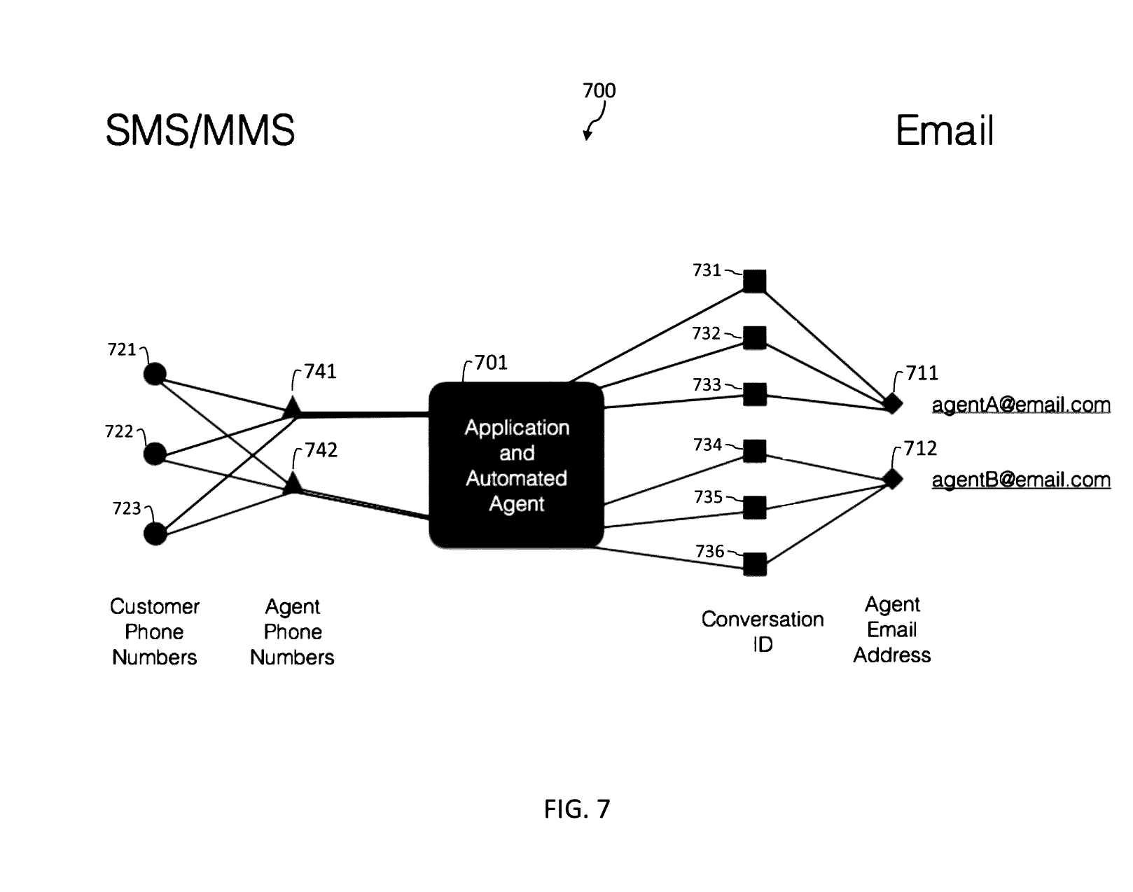

Referring to FIG. 7, system 700 provides for communication using text messages and email. Application 701 interacts with agent devices via agent email addresses 711 and 712 and interacts with user devices via customer phone numbers 721, 722, and 723.

Application 701 runs on a server of a survey system, such as survey system 102 of FIG. 1.

The agent devices are communication devices, such as the communication devices of users 105 of FIG. 1. In one embodiment, the agent devices are personal computers that include software to send and receive emails.

The user devices are communication devices similar to the communication devices of users 105 of FIG. 1. In one embodiment, the user devices are phones that include software to send and receive SMS or MMS messages.

Application 701 bridges email and SMS/MMS technology to create seamless communication between agent devices (using email) and user devices (using SMS/MMS). An agent uses common email applications (such as outlook etc.) to converse with a customer that uses common messaging application to respond. Any number of agents can converse with any number of customers. Additionally, any number of messages are exchanged between a customer and an agent.

Any message received from an agent via email is converted into SMS (or MMS if it contains media), and sent to a user device of a customer. Any message received from a user device of a customer via SMS/MMS is converted into email, and sent to the email address of the agent. Any number of messages are sent from agents to customers and vice-versa.

Application 701 provides a seamless method for multiple agents (belonging to the same or different businesses) to converse with many customers. In one embodiment, application 701 assigns two assets to make the conversation between an agent and a customer seamless. The first asset is a conversation identifier (ID) and the second asset is an agent phone number. Application 701 automatically assigns a unique conversation ID to each and every pair of a customer phone number and an agent email address. The conversation IDs are shown as conversation IDs 731 through 736. Application 701 also assigns a unique phone number, such as one of agent phone numbers 741 and 742 to an agent email address. In one embodiment, a conversation ID includes a plurality of alphanumeric characters that uniquely identify one conversation from other conversations.

The application inserts a conversation ID into an email (e.g., in the subject line) so that when an agent replies to the email, the conversation ID is returned to and identified by application 701. Using the conversation ID, application 701 can determine the one of customer numbers 721 through 723 that was intended to receive this message. Parameters others than subject line can be used to carry the conversation ID. In this manner, incoming email messages are always directed to the correct customer. Every conversation ID is uniquely mapped to a customer phone number and a customer phone number may be mapped to multiple conversation IDs. FIG. 7 shows conversation ID 731 mapped to customer phone number 721 and customer phone number 721 mapped to both conversation ID 731 and to conversation ID 734.

When a conversation ID is present in the subject line of an email, the conversation ID is formatted such that it can be easily identified and parsed from the subject field. Additionally, the conversation ID is encrypted to protect the information.

Messages are sent to the customer via an agent phone number, so that when the customer replies, application 701 automatically maps the message to the correct email address an agent. In this manner, incoming SMS messages are always directed to the correct email address. One agent phone number is mapped to one agent email addresses. FIG. 7 shows agent phone number 741 mapped to agent email address 711. Additionally, one agent email address may be mapped to multiple agent phone numbers (not shown).

Application 701 uses an automated agent (software program) to analyze the messages flowing between customer and agent. The automated agent of application 701 sits in the middle, and couriers messages from customer to agent, and agent to customer.

Based on the analysis, the automated agent of application 701 may decide to automatically respond to a query from a customer. Optionally, the automated agent of application 701 may decide to forward the message to an agent email address when the automated agent of application 701 is unable to respond.

The automated agent of application 701 uses natural language processing technology and machine learning algorithms to compute the best possible response to a message received from customer. The automated agent of application 701 uses automatic methods to extract dates, names, addresses and other special information. In the email sent to the agent email address, the automated agent of application 701 identifies the automatically extracted information. For example, the automated agent of application 701 may highlight the parsed information, such as dates, names, addresses and other special information.

The automated agent of application 701 prepares a conversation history and inserts the conversation history into the email. This provides the agent context of the conversation in every email. In one embodiment, the conversation history includes information from prior email messages associated with the conversation ID.

The automated agent of application 701 can optionally choose the best response from a prepared list of responses. For example, the response for greeting and thanking can be pre-determined to be ‘Greetings from XYZ company!’ and ‘Thank you!’. In this case, the automated agent of application 701 only computes that it must greet or thank, and then picks up the pre-determined message as response (as opposed to constructing the message).

The conversation between agents and customers is stored and used for training, adapting and/or improving the performance of the automated agent of application 701. The stored conversation is used to teach the automated agent new methods of responding and is used to teach the automated agent new information to extract.

In one embodiment, the automated agent of application 701 senses sentiment in the conversation. The automated agent of application 701 decides to escalate conversations to the supervisor if it detects negative sentiment.

In one embodiment, the automated agent of application 701 tracks topics and themes in the conversation. The automated agent of application 701 decides to escalate conversations to the supervisor if the automated agent of application 701 detects keywords or themes such as cancelation etc.

In one embodiment, the automated agent of application 701 monitors agent language to detect inappropriate language and monitors the media content to detect inappropriate content. Upon detection, the automated agent of application 701 blocks the outgoing message and escalates to a supervisor. The automated agent of application 701 uses keyword spotting and other natural language processing techniques to determine inappropriateness. It makes decision based on specific words or the tone/sentiment of the message (e.g., the use of confrontational words or tone).

An automated process of application 701 tracks the number of turns taken and the time taken to respond by an agent. The automated process of application 701 uses this and other meta information to rate agent performance. By measuring the performance for various agents, the automated process of application 701 creates gamification where the best performing agent is rewarded for good performance.

The outbound SMS system contains rules that prevent system abuse. It does not send outbound SMS messages at night or on weekends/holidays to respect customer privacy. Compliance with Telephone Consumer Protection Act (TCPA) laws is built in to the process.

The outbound SMS system contains rate limiting rules that prevent more than a specified number of messages to be delivered to the customer per one or more of a day, a month, a quarter, a year, or other unit of time.

In one embodiment, two agents communicate with three customers. The two agents are associated to agent email addresses 711 and 712. Agent email addresses 711 is agentA@email.com and agent email address 712 is agentB@email.com. The three customers are associated with customer phone numbers 721, 722, and 723.

When a message is sent from agentA@email.com to the three customers, the system creates three (3) conversations IDs 731, 732 and 733 and maps conversation ID 731 to a tuple of (agent email address 711, customer phone number 721), conversation ID 732 to a tuple of (agent email address 711, customer phone number 722), and conversation ID 733 to a tuple of (agent email address 711, customer phone number 723). Additionally, the system assigns agent phone number 741 to agent email address 711.

When a message is sent from agentB@email.com to the three customers, the system creates three (3) conversations IDs 734, 735 and 736 and maps conversation ID 734 to a tuple of (agent email address 712, customer phone number 721), conversation ID 735 to a tuple of (agent email address 712, customer phone number 722) and conversation ID 736 to a tuple of (agent email address 712, customer phone number 723). Additionally, the system assigns agent phone number 742 to agent email address 712.

Email messages from agent email address 711 are sent to customer phone numbers 721, 722 and 723 using agent phone number 741, and from email message from agent email address 712 are sent to customer phone numbers 721, 722, 723 using agent phone number 742.

When customers reply with an SMS to agent phone number 741, the system can determine that the messages are to be sent to agentA@email.com. When customers reply with an SMS to agent phone number 742, the system can determine that the messages are to be sent to agentB@email.com.

When the system sends an email to agentA@email.com that was constructed from a message from customer phone number 721, the system inserts conversation ID 731 into the subject line, e.g. sub: ID=0001. The conversation ID 731 is also included in a reply from agent email address 711. When the system receives the reply from agent email address 711, the system parses the conversation ID from the subject line of the reply. From the conversation ID value parsed from the subject line, the system knows the customer and customer phone number that should receive the agent's message.

Application 701 can connect any number of agents using agent email addresses with any number of customers using customer phone numbers and seamlessly deliver the right message to the right recipient.

In one embodiment, the system performs a method described in the steps below. The first and second steps are repeated for any new combination of an agent email address (AE) and a customer phone number (CP). The third through sixth steps are repeated for each incoming SMS message. The seventh and eighth steps are repeated for each incoming email message.

At the first step, a conversation ID (ID) is assigned to pair comprising a customer phone number (CP) and an agent email address (AE).

At the second step, an agent phone number (AP) is assigned to agent email address (AE).

At the third step, for an incoming SMS message, a customer phone number (CP) and agent phone number (AP) are extracted from the SMS message. When the customer is sending a message to an agent, the CP is the number from which the message is sent and the AP is the number to which the message is sent, and vice versa.

At the fourth step, the agent email address (AE) that corresponds to the AP is determined.

At the fifth step, a conversation ID is determined from the AE and the CP.

At the sixth step, an email message is constructed and sent to the AE. The customer's message is inserted into the body of an email and the ID is inserted into the subject of the email to construct the email message. The constructed email is then sent to the AE.

At the seventh step, for an incoming email message, the conversation ID (ID) is parsed from the subject line of the email and the agent email address (AE) is parsed from the header of the email. From the ID and AE, a customer phone number (CP) is determined. From the AE, the agent's phone number (AP) is determined.

At the eighth step, an SMS message is constructed from the incoming email. The email body is used to construct the SMS body. If multimedia is present, then the method creates an MMS message instead of an SMS message. The newly constructed message is sent to the CP determined from the ID and AE of the incoming email message.

In one embodiment, a customer contact spreadsheet comprises contact information about each customer. The customer contact spreadsheet is received by the system, which then automatically sends an SMS message to the customers identified in the customer contact spreadsheet using the body (i.e., the text) of the email as the body or text of the SMS message.

It will be appreciated by those skilled in the art that modifications can be made to the embodiments disclosed and remain within the inventive concept. Therefore, this invention is not limited to the specific embodiments disclosed, but is intended to cover changes within the scope and spirit of the claims.

1. In a system comprising a network, a first client device connected to the network, a second client device connected to the network, a survey server connected to the network, and a social media server connected to the network, the survey server programmed to store and execute instructions that cause the system to perform a method comprising the steps of:
sending, by the survey server to the first client device, a message with a portion of bio information sent by the second client device;
receiving, by the survey server from the first client device, a message with a code;
sending, by the survey server to the first client device in response to the message with the code, a message with a link to a social media selection page; and,
sending, by the survey server to the first client device in response to receiving a request for the social media selection page, the social media selection page, which comprises one or more portions of the social media information.

2. The method of claim 1, further comprising the step of:
receiving, by the survey server from the client device, the bio information and the social media information associated with an operator of the second client device;

3. The method of claim 2, further comprising the step of:
receiving, by the survey server from the first client device in response to a selection of the link to the social media selection page, the request for the social media selection page;

4. The method of claim 3, wherein the first client device displays the social media selection page.

5. The method of claim 4, wherein the first client device receives a selection of a social media link displayed on the social media selection page.

6. The method of claim 5, wherein the first client device sends a request for a review page associated with the social media link and with the social media information to the social media server.

7. The method of claim 6, wherein the social media server receives the request for the review page from the first client device.

8. The method of claim 7, wherein the social media server sends the review page to the first client device.

9. The method of claim 8, wherein the first client device displays the review page associated with the social media information.

10. The method of claim 9, wherein the first client device sends review information to the social media server.

11. A system for providing review comprising
a network;
a first client device connected to the network;
a second client device connected to the network;
a survey server connected to the network; and
a social media server connected to the network;
the survey server programmed to carry out the steps of:
sending, by the survey server to the first client device, a message with a portion of the bio information;
receiving, by the survey server from the first client device, a message with a code;
sending, by the survey server to the first client device in response to the message with the code, a message with a link to a social media selection page; and,
sending, by the survey server to the first client device in response to receiving the request for the social media selection page, the social media selection page, which comprises one or more portions of the social media information.

12. The system of claim 11, wherein the survey server is further programed to carry out the step of:
receiving, by the survey server from the client device, bio information and social media information associated with an operator of the second client device;

13. The system of claim 12, wherein the survey server is further programed to carry out the step of:
receiving, by the survey server from the first client device in response to a selection of the link to the social media selection page, the request for the social media selection page;

14. The system of claim 13, wherein the first client device displays the social media selection page.

15. The system of claim 14, wherein the first client device receives a selection of a social media link displayed on the social media selection page.

16. The system of claim 15, wherein the first client device sends a request for a review page associated with the social media link and with the social media information to the social media server.

17. The system of claim 16, wherein the social media server receives the request for the review page from the first client device.

18. The system of claim 17, wherein the social media server sends the review page to the first client device.

19. The system of claim 18, wherein the first client device displays the review page associated with the social media information.

20. The system of claim 19, wherein the first client device sends review information to the social media server.
